(19) United States
(12) Patent Application Publication
(10) Pub. No.: US 2021/0397702 A1
(43) Pub. Date: Dec. 23, 2021

(54) RISK ANALYZER AND RISK ANALYSIS METHOD

(71) Applicant: Panasonic Intellectual Property Management Co., Ltd., Osaka (JP)

(72) Inventors: Hiroshi AMANO, Osaka (JP); Yusuke NEMOTO, Hyogo (JP); Minehisa NAGATA, Osaka (JP); Yosuke TAJIKA, Hyogo (JP)

(73) Assignee: Panasonic Intellectual Property Management Co., Ltd., Osaka (JP)

(21) Appl. No.: 17/466,289

(22) Filed: Sep. 3, 2021

Related U.S. Application Data
(63) Continuation of application No. PCT/JP2020/011657, filed on Mar. 17, 2020.

(30) Foreign Application Priority Data
Mar. 20, 2019 (JP) 2019-052294

(51) Int. Cl. G06F 21/55

(52) U.S. Cl. CPC G06F 21/552

(57) ABSTRACT

A risk analyzer analyzing a risk of a system including N (natural number greater than or equal to 2) elements connected includes: an inputter receiving, as inputs, a degree of safety of each N element against a threat to security, a connection relationship of the N elements, an entry point being an element serving as an entry to the system, and a defense target being an element protected in the system; an identifier identifying, among one or more paths from the entry point to the defense target, based on the degrees of safety and the connection relationship of the N elements, a target path in which a total sum of the degrees of safety of elements passed while the target path extends from the entry point to the defense target is lower than a threshold value; and an outputter outputting path information on the target path.

### CROSS REFERENCE TO RELATED APPLICATIONS

This is a continuation application of PCT International Application No. PCT/JP2020/011657 filed on Mar. 17, 2020, designating the United States of America, which is based on and claims priority of Japanese Patent Application No. 2019-052294 filed on Mar. 20, 2019.

### FIELD

The present disclosure relates to risk analyzers and risk analysis methods.

### BACKGROUND

In recent years, unauthorized attacks on control systems in industrial devices such as manufacturing facilities have stopped the manufacturing facilities. In order to prevent unauthorized programs from being installed in products at the time of manufacturing, high security is required for control systems in industrial devices. In order to cope with this requirement, for example, PTL 1 discloses a security measure planning support system which supports security measures for control systems.

### CITATION LIST

### Patent Literature

PTL 1: Japanese Unexamined Patent Application Publication No. 2018-77597

### Non Patent Literature

NPL 1: “Security Risk Assessment Guide for Industrial Control Systems”, IPA Information-technology Promotion Agency, Japan, Oct. 2, 2017

### SUMMARY

However, the conventional security measure planning support system described above can be improved upon.

In view of this, the present disclosure provides a risk analyzer and a risk analysis method capable of improving upon the above related art.

In order to overcome the above disadvantage, a risk analyzer according to an aspect of the present disclosure is a risk analyzer that analyzes a risk of a system including N elements connected to each other, N being a natural number greater than or equal to 2, and the risk analyzer includes: an inputter that receives, as inputs, a degree of safety of each of the N elements against a threat to security, a connection relationship of the N elements, an entry point which is an element serving as an entry to the system, and a defense target which is an element to be protected in the system; an identifier that identifies, among one or more paths from the entry point to the defense target, based on the degrees of safety and the connection relationship of the N elements, a target path in which a total sum of the degrees of safety of elements passed while the target path extends from the entry point to the defense target is lower than a first threshold value; and an outputter that outputs path information on the target path.

A risk analysis method according to an aspect of the present disclosure is a risk analysis method for analyzing a risk of a system including N elements connected to each other, N being a natural number greater than or equal to 2, and the risk analysis method includes: receiving, as inputs, a degree of safety of each of the N elements against a threat to security, a connection relationship of the N elements, an entry point which is an element serving as an entry to the system, and a defense target which is an element to be protected in the system; identifying, among one or more paths from the entry point to the defense target, based on the degrees of safety and the connection relationship of the N elements, a target path in which a total sum of the degrees of safety of elements passed while the target path extends from the entry point to the defense target is lower than a threshold value; and outputting path information on the target path.

These comprehensive or specific aspects may be realized by a system, a method, an integrated circuit, a computer program, or a computer-readable recording medium such as a CD-ROM or may be realized by any combination of a system, a method, an integrated circuit, a computer program, and a recording medium. The recording medium may be a non-transitory recording medium.

With the risk analyzer and the risk analysis method according to the present disclosure, it is possible to achieve further improvement.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram showing an example of a control system which is the target of a risk analysis performed by a risk analyzer according to Embodiment 1.

FIG. 2 is a block diagram showing the configuration of the risk analyzer according to Embodiment 1.

FIG. 3 is a flowchart showing the operation of the risk analyzer according to Embodiment 1.

FIG. 4 is a diagram which is produced based on input information in the risk analyzer according to Embodiment 1 and which is used for illustrating an undirected graph of a system serving as the target of a risk analysis.

FIG. 5 is a diagram for illustrating processing for converting the undirected graph into a directed graph in the risk analyzer according to Embodiment 1.

FIG. 6 is a diagram showing target paths identified in the system shown in FIG. 4.

FIG. 7 is a diagram showing the union of the target paths shown in FIG. 6.

FIG. 8 is a flowchart showing the operation of a risk analyzer according to a variation of Embodiment 1.

FIG. 9 is a flowchart showing the operation of a risk analyzer according to Embodiment 2.

FIG. 10 is a diagram which is produced based on information input to the risk analyzer according to Embodiment 2 and which is used for illustrating an undirected graph of a system serving as the target of a risk analysis.

FIG. 11 is a diagram showing a union of target paths when element exclusion processing is not performed in the system shown in FIG. 10.

FIG. 12 is a diagram showing a union of target paths when the element exclusion processing is performed in the system shown in FIG. 10.

FIG. 13 is a flowchart showing the operation of a risk analyzer according to a variation of Embodiment 2.

FIG. 14 is a diagram showing an example of a system serving as the target of a risk analysis performed by a risk analyzer according to Embodiment 3.

FIG. 15 is a diagram showing an example of a system serving as the target of a risk analysis performed by a risk analyzer according to Embodiment 4.

### DESCRIPTION OF EMBODIMENTS

(Outline of Present Disclosure)

The present inventors have found that the security measure planning support system described in the section of “Background” has the following disadvantage.

When the conventional security measure planning support system described above is utilized to take security measures for a control system, there are a huge number of attack paths for threat items. Since a connection relationship between the assets of the control system is generally complicated, it is difficult to cover all the attack paths. Hence, with the conventional security measure planning support system, it is impossible to support sufficient security measures.

Therefore, the present disclosure provides a risk analyzer and a risk analysis method which can support sufficient measures for increasing the security of a defense target.

In order to overcome the above disadvantage, a risk analyzer according to an aspect of the present disclosure is a risk analyzer that analyzes a risk of a system including N elements connected to each other, N being a natural number greater than or equal to 2, and the risk analyzer includes: an inputter that receives, as inputs, a degree of safety of each of the N elements against a threat to security, a connection relationship of the N elements, an entry point which is an element serving as an entry to the system, and a defense target which is an element to be protected in the system; an identifier that identifies, among one or more paths from the entry point to the defense target, based on the degrees of safety and the connection relationship of the N elements, a target path in which a total sum of the degrees of safety of elements passed while the target path extends from the entry point to the defense target is lower than a first threshold value; and an outputter that outputs path information on the target path.

In this way, the target path for which measures against a threat to security need to be taken is easily identified. Hence, in the present aspect, it is possible to support sufficient measures for increasing the security of the defense target.

For example, in a risk analyzer according to an aspect of the present disclosure, the identifier may use a shortest path method to identify the target path.

In this way, a shortest path method is used, and thus it is possible to identify the target path with a small amount of computation. Hence, in the present aspect, it is possible to support sufficient measures for increasing the security of the defense target with a small amount of computation.

For example, in a risk analyzer according to an aspect of the present disclosure, the identifier may further exclude, from the N elements, M elements each having a degree of safety greater than or equal to a second threshold value, and identify the target path based on N−M elements which are not excluded, M being a natural number of 1 or more.

In this way, the M elements each having a high degree of safety are previously excluded, and thus it is possible to further reduce the amount of computation necessary for identifying the target path.

For example, in a risk analyzer according to an aspect of the present disclosure, the system may be a control system, and the N elements may be N assets of the control system.

In this way, it is possible to perform a risk analysis on a control system in which a large number of assets are provided and in which the connection relationship is complicated. A control system installed in a factory may include, for example, a device in which an operation system (OS) is not supported or a device on which processing for increasing the degree of safety cannot be performed in the first place. In other words, it is not always possible to constantly take security measures for all assets included in the control system. In terms of availability required for a control system, there is an asset for which security measures such as the restriction of transmission and reception of control commands should not be taken.

Even in such a case, in the present aspect, among the paths from the entry point to the defense target, the target path for which measures against a threat to security need to be taken is identified, and thus it is possible to select the elements on which security measures can be performed among the elements located on the target path so as to interrupt the identified target path. Hence, it is possible to support sufficient measures for increasing the security of the defense target for the control system.

For example, in a risk analyzer according to an aspect of the present disclosure, the system may be a control system, and the N elements may be a plurality of attack steps included in attack procedures for a plurality of assets of the control system.

In this way, it is possible to perform a risk analysis which includes not only the connection relationship between the assets but also the attack procedures within the assets. Hence, a more specific target path is provided, and thus it is possible to effectively support sufficient measures for increasing the security of the defense target.

For example, in a risk analyzer according to an aspect of the present disclosure, the system may be an attack procedure for an asset of a control system, and the N elements may be N attack steps included in the attack procedure.

In this way, it is possible to perform a risk analysis based on the attack procedures within the assets, and thus it is possible to support sufficient measures for increasing the security of the defense target for the assets.

For example, in a risk analyzer according to an aspect of the present disclosure, the inputter may receive, as inputs, a plurality of entry points each being the entry point and a plurality of defense targets each being the defense target, and the identifier may identify the target path for each combination of an entry point and a defense target from among the plurality of entry points and the plurality of defense targets.

In this way, even when a plurality of entry points and a plurality of defense targets are included in the system, it is possible to support sufficient measures for increasing the security of the defense targets.

For example, in a risk analyzer according to an aspect of the present disclosure, when the identifier identifies a plurality of target paths each being the target path, the outputter may output, as the path information, information indicating a union of the plurality of target paths.

In this way, since the path information is indicated by the union of a plurality of target paths, as compared with a case where elements on which security measures need to be performed are determined for each of a plurality of target paths, it is possible to easily select elements on which security measures need to be performed.

For example, a risk analysis method according to an aspect of the present disclosure is a risk analysis method for analyzing a risk of a system including N elements connected to each other, N being a natural number greater than or equal to 2, and the risk analysis method includes: receiving, as inputs, a degree of safety of each of the N elements against a threat to security, a connection relationship of the N elements, an entry point which is an element serving as an entry to the system, and a defense target which is an element to be protected in the system; identifying, among one or more paths from the entry point to the defense target, based on the degrees of safety and the connection relationship of the N elements, a target path in which a total sum of the degrees of safety of elements passed while the target path extends from the entry point to the defense target is lower than a threshold value; and outputting path information on the target path.

In this way, the target path for which measures against a threat to security need to be taken is easily identified. Hence, in the present aspect, it is possible to support sufficient measures for increasing the security of the defense target.

For example, a recording medium according to an aspect of the present disclosure is a non-transitory computer-readable recording medium in which a program for causing a computer to execute the risk analysis method described above is recorded.

Embodiments will be specifically described below with reference to drawings.

The embodiments described below show comprehensive or specific examples. Values, shapes, materials, constituent elements, the arrangement and connection form of the constituent elements, steps, the order of the steps, and the like which are shown in the embodiments below are examples and are not intended to limit the present disclosure. Among the constituent elements in the embodiments below, constituent elements which are not recited in independent claims will be described as arbitrary constituent elements.

The drawings are schematic views and are not exactly shown. Hence, for example, scales and the like in the drawings are not necessarily the same. In the drawings, substantially the same configurations are identified with the same reference signs, and repeated description thereof will be omitted or simplified.

### Embodiment 1

### [Outline of System Serving as Target of Risk Analysis]

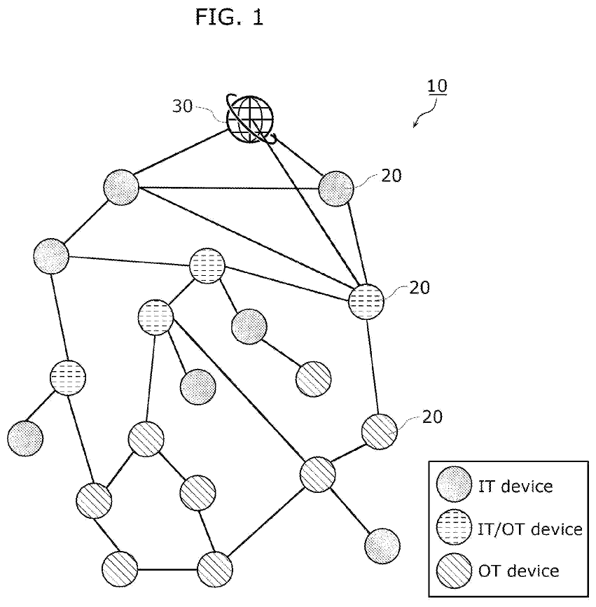

An outline of a control system which is an example of a system serving as the target of a risk analysis performed by a risk analyzer according to Embodiment 1 will first be described with reference to FIG. 1. FIG. 1 is a diagram showing an example of control system 10 according to the present embodiment.

As shown in FIG. 1, control system 10 includes N elements 20 which are connected to each other. Here, N is a natural number greater than or equal to 2. In FIG. 1, N elements 20 are represented by shaded circles. Each of N elements 20 is connected to at least one of other elements 20.

In the present embodiment, elements 20 are the assets of control system 10. The assets are, for example, devices such as a communication device, a control device, a manufacturing facility, an information processing device, a sensor, a drive device, and a storage device. The assets are connected to be able to communicate with each other. The asset can communicate unidirectionally or bidirectionally with the other asset which is connected, and transmits or receives information or signals.

Control system 10 is, for example, a system which controls an industrial device. Control system 10 is, for example, a system which is installed in a factory for manufacturing products such as electronic devices. As shown in FIG. 1, control system 10 is connected to Internet 30. N elements 20 include, as examples of the asset, information technology (IT) devices, operational technology (OT) devices, and IT/OT devices.

The IT device has, for example, a communication function capable of connecting to Internet 30. An IT device which is not connected to Internet 30 may be included in the IT devices of control system 10. The OT device is a device which performs control based on physical conditions. For example, the OT device detects a temperature, a pressure, or the like to control a valve, a motor, or the like based on the result of the detection. The IT/OT device is a device which has both the functions of the IT device and the OT device.

As shown in FIG. 1, in control system 10 installed in a general factory, the connection of the IT devices, the OT devices and the IT/OT devices is not organized, and the devices are connected in a complicated manner. The connection relationship thereof is also changed such as by removal of an existing device and addition of a new device. Since in general control system 10, importance is placed on availability, it is often difficult to organize the connection relationship of the devices. Hence, it is difficult to identify a device for which security measures need to be taken.

As the number of devices is increased and the connection relationship is more complicated, the number of paths from a device serving as an entry point to a device serving as an attack target is significantly increased. Hence, it is difficult to determine whether or not measures need to be taken for all devices and paths.

A risk analyzer and a risk analysis method will be described below which can support sufficient measures for control system 10 as shown in FIG. 1 to increase the security of a defense target with a small amount of computation.

### [Risk Analyzer]

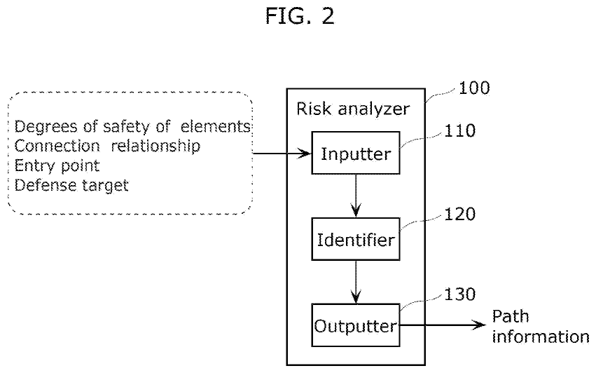

FIG. 2 is a block diagram showing the configuration of risk analyzer 100 according to the present embodiment. Risk analyzer 100 analyzes the risk of a system (for example, control system 10 shown in FIG. 1) including N elements connected to each other. In the present embodiment, risk analyzer 100 identifies, in the system having N assets, a path which can serve as an attack path for a predetermined asset. Risk analyzer 100 is, for example, a computer device.

As shown in FIG. 2, risk analyzer 100 includes inputter 110, identifier 120 and outputter 130.

Inputter 110 receives, as inputs, information used for identifying a path. Specifically, as shown in FIG. 2 inputter 110 receives, as inputs, the degree of safety of each of the N elements against a threat to security, the connection relationship of the N elements, an entry point which is an element serving as an entry to the system, and a defense target which is an element to be protected in the system. In the present embodiment, N is the total number of elements of the system. The N elements are the N assets of the control system.

The degree of safety is a value which is determined for each asset based on an asset-based risk analysis. For example, the degree of safety is determined based on a DREAD model. The degree of safety means that as its value is increased, safety against a threat to security is increased. The asset-based risk analysis is performed, for example, by a method disclosed in NPL 1.

The connection relationship is information indicating all pairs of two assets which are connected to be able to communicate with each other. The connection relationship may further include the direction of connection. For example, in a case where asset A and asset B are connected together, when asset A can transmit information to asset B but asset B cannot transmit information to asset A, a connection relationship between asset A and asset B may include the direction of connection from asset A to asset B.

The entry point is an asset through which an entry from the outside is allowed. The entry point is, for example, an asset which is connected to Internet 30. The entry point may also be an asset which has an interface capable of connecting a memory device such as a universal serial bus (USB) memory or another device. The defense target is an asset which is determined based on a business damage-based risk analysis. Specifically, the defense target is an asset in which when the asset receives an attack, a business damage is increased beyond a given reference. The business damage-based risk analysis is performed, for example, by a method disclosed in NPL 1.

As described above, each of the degree of safety, the connection relationship, the entry point, and the defense target is objectively determined based on a predetermined method. Hence, since no artificial evaluation is involved, variations in evaluation based on the skills of evaluators are not produced. Therefore, it is possible to stably support sufficient measures for increasing the security of the defense target.

Inputter 110 may receive, as an input, a plurality of entry points or a plurality of defense targets. Processing when inputter 110 receives, as inputs, a plurality of entry points or a plurality of defense targets will be described later as a variation of Embodiment 1.

In the present embodiment, inputter 110 further acquires a first threshold value. The first threshold value is a value used for comparison with a total sum of the degrees of safety of assets passed while a path extends from the entry point to the defense target. The first threshold value is a safety criterion which needs to be satisfied by the path from the entry point to the defense target. When the total sum of the degrees of safety is greater than or equal to the first threshold value, the path is safe, and the security of an asset serving as the defense target is sufficiently high. In other words, it can be determined that it is not necessary to take measures against a threat to security. When the total sum of the degrees of safety is less than the first threshold value, the path cannot be said to be safe, and the security of the asset serving as the defense target is low. In other words, it can be determined that it is necessary to take measures against the threat to security for the path.

Inputter 110 stores, in a storage (not shown), input information acquired by receiving information as inputs. The storage may be included in risk analyzer 100 or may be an external storage device which can communicate with risk analyzer 100.

Inputter 110 is at least one of input devices such as a keyboard, a mouse, and a touch panel. Inputter 110 may also be a communication interface which is connected to a storage device or the like.

Identifier 120 identifies, among one or more paths from the entry point to the defense target, based on the degrees of safety and the connection relationship of the N elements, a target path in which a total sum of the degrees of safety of elements passed while the target path extends from the entry point to the defense target is lower than the first threshold value. As described above, the target path is a path for which measures need to be taken against the threat to security. In other words, the target path is an attack path for the defense target.

In the present embodiment, identifier 120 uses a shortest path method to identify the target element. Specifically, identifier 120 uses, as the shortest path method, Dijkstra's algorithm, Bellman-Ford algorithm, or Warshall-Floyd Algorithm. For example, in a graph where assets are assumed to be vertices (nodes), with the entry point set to a starting point and the defense target set to an end point, the path which is the kth shortest (that is, the kth shortest path) is derived. As a specific algorithm for deriving the kth shortest path, Dijkstra's algorithm using a priority queue or the algorithm of Eppstein, Yen, or Hershberger can be used. These methods are only examples, and a means for identifying the target path by identifier 120 is not limited to these methods.

Identifier 120 is realized by a nonvolatile memory in which programs are stored, a volatile memory which is a temporary storage region for executing a program, an input/output port, a processor which executes a program, and the like. The functions of identifier 120 may be realized by software executed in the processor or may be realized by hardware such as an electrical circuit including one or more electronic components.

Outputter 130 outputs path information on the target path identified by identifier 120. In the present embodiment, when a plurality of target paths are identified by identifier 120, outputter 130 outputs, as the path information, information indicating a union of the target paths.

Outputter 130 is at least one output device such as a display or a printer. Outputter 130 may also be a communication interface for an external device which can communicate with risk analyzer 100.

### [Operation (Risk Analysis Method)]

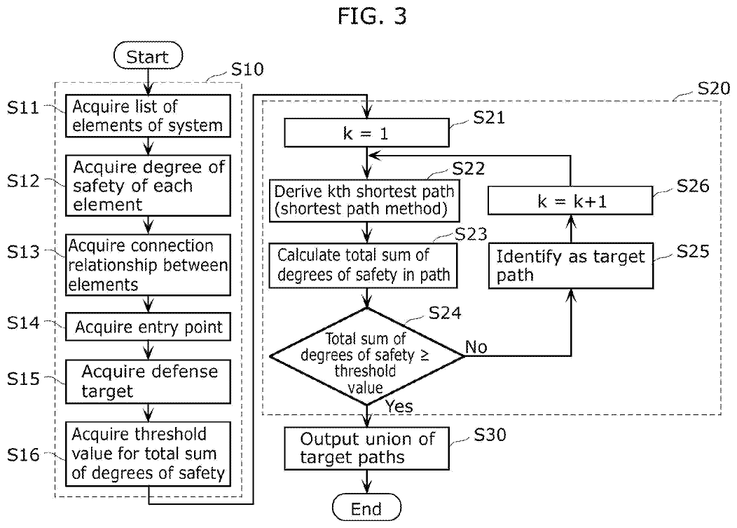

Then, the operation of risk analyzer 100 according to the present embodiment, that is, the risk analysis method will be described with reference to FIG. 3. FIG. 3 is a flowchart showing the operation of risk analyzer 10 according to the present embodiment.

As shown in FIG. 3, inputter 110 first acquires the input information necessary for identifying the target path (S10). Specifically, inputter 110 acquires a list of the elements of the system (S11). The list of the elements is a list of information for identifying all assets included in the system. Then, inputter 110 acquires the degree of safety of each element (S12), and then acquires the connection relationship between the elements (S13). Furthermore, inputter 110 acquires the entry point (S14) and then acquires the defense target (S15). Inputter 110 further acquires a threshold value for a total sum of the degrees of safety (S16).

The order in which inputter 110 acquires the pieces of information is not particularly limited. For example, inputter 110 may acquire a correspondence table to which, for each element, the degree of safety, an element connected, a flag indicating whether or not the element is the entry point, and a flag indicating whether or not the element is the defense target are made to correspond. Inputter 110 acquires the correspondence table to be able to simultaneously acquire the list of the elements, the degrees of safety, the connection relationship, the entry point, and the defense target.

Then, identifier 120 identifies the target path with the shortest path method based on the information acquired by inputter 110 (S20). Processing indicated in step S20 is processing for identifying the target path which is performed when both only one entry point and only one defense target are provided.

Specifically, identifier 120 first makes a setting such that k=1 (S21). Identifier 120 uses the shortest path method to derive the kth shortest path among paths from the entry point to the defense target (S22) and to calculate a total sum of the degrees of safety of the derived path (S23).

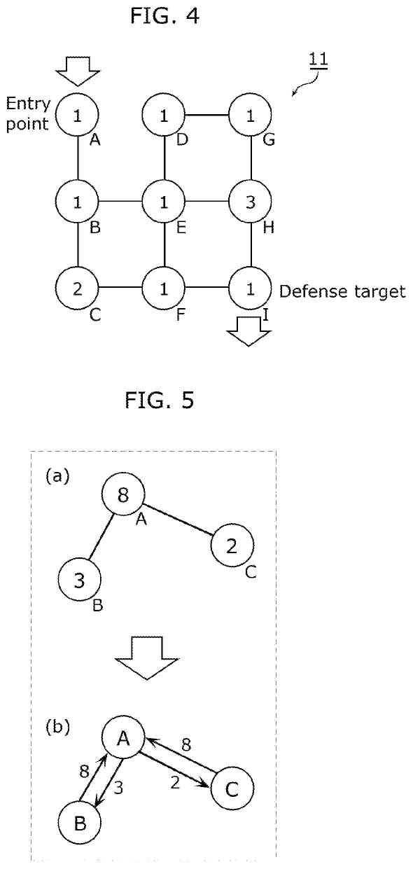

Specifically, identifier 120 produces, based on the input information acquired by inputter 110, an undirected graph in which the N assets are assumed to be vertices and in which the degrees of safety of the assets are assumed to be the weights of the vertices. Edges between the vertices in the undirected graph are determined based on the connection relationship of the N assets. For example, identifier 120 produces an undirected graph as shown in FIG. 4. Control system 11 shown in FIG. 4 is a control system formed with nine assets A to I connected to each other. Asset A is the entry point. Asset I is the defense target.

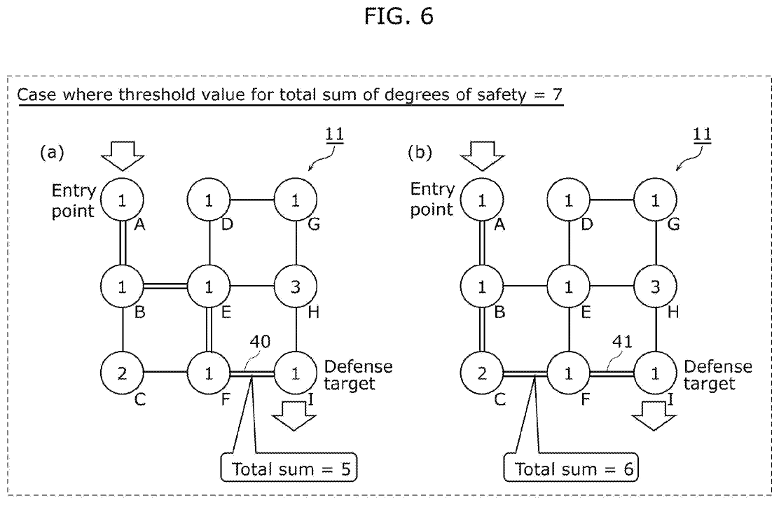

Here, FIG. 4 is a diagram which is produced based on the information input to risk analyzer 100 according to the present embodiment and which is used for illustrating the undirected graph of control system 11 serving as the target of a risk analysis. In FIG. 4, the assets (vertices) of control system 11 are represented by white circles. Values displayed in the white circles indicate the degrees of safety of the assets. The degrees of safety are the weights of the vertices in the undirected graph. A line segment (edge) connecting two assets (circles) indicates that the two assets are connected to be able to communicate with each other. An open arrow directed toward an asset indicates that the asset is the entry point. An open arrow extending from an asset indicates that the asset is the defense target. This is the same as in FIGS. 6, 7, and 10 to 12, which will be described later.

Then, identifier 120 converts the undirected graph produced into a directed graph, and thereafter gives weights to directed edges. Here, FIG. 5 is a diagram for illustrating processing for converting the undirected graph into the directed graph in risk analyzer 100 according to the present embodiment. For example, identifier 120 converts the undirected graph with weights given to the vertices shown in (a) of FIG. 5 into the directed graph with weights given to edges shown in (b) of FIG. 5.

Specifically, identifier 120 first converts edges connecting two assets into directed edges extending in both directions. Then, identifier 120 gives, to the weights of the directed edges input to the assets, that is, the weights of the directed edges represented by the arrows whose tips are connected to the assets, the weights (that is, the degrees of safety) of the assets.

Identifier 120 uses, based on the directed graph, the shortest path method to derive a path in which a total sum of the degrees of safety of all assets located on the path is the kth smallest among all the paths from the entry point to the defense target. Here, since k=1, identifier 120 identifies, as the target path, a path in which the total sum of the degrees of safety is the smallest among all the paths from the entry point to the defense target.

FIG. 6 is a diagram showing the target path identified in control system 11 shown in FIG. 4. In FIG. 6, the identified target path is represented by double lines. Here, a case where the first threshold value used for comparison with the total sum of the degrees of safety is 7 is shown.

As shown in (a) of FIG. 6, the total sum of the degrees of safety in path 40 where asset A, asset B, asset E, asset F, and asset I are shown in this order is 5. In control system 11, path 40 is a path in which the total sum of the degrees of safety is the smallest. In control system 11 shown in FIG. 6, the path in which the total sum of the degrees of safety is 6 is only path 40.

After the calculation of the total sum of the degrees of safety, as shown in FIG. 3, identifier 120 compares the total sum of the degrees of safety with the first threshold value (S24). Specifically, when the total sum of the degrees of safety is lower than the first threshold value (No in S24), identifier 120 identifies, as the target path, the derived path, that is, the path in which the total sum of the degrees of safety is lower than the first threshold value (S25). Then, identifier 120 increases the value of k by 1 (S26) to sequentially perform the derivation of the shortest path, the calculation of the total sum of the degrees of safety, and the comparison with the first threshold value (S22 to S24). Until the total sum of the degrees of safety is greater than or equal to the first threshold value, as the value of k is increased by 1, steps S22 to S24 are repeated. In this way, among the paths from the entry point to the defense target, all the paths in which the total sum of the degrees of safety is lower than the first threshold value can be identified as the target paths.

For example, the total sum of the degrees of safety in path 40 shown in (a) of FIG. 6 is 5 and is lower than 7 which is the first threshold value. Hence, identifier 120 sets the value of k to 2 to identify, as the target path, the second shortest path, that is, a path in which the total sum of the degrees of safety is the second smallest among all the paths from the entry point to the defense target. In this way, as shown in (b) of FIG. 6, the total sum of the degrees of safety in path 41 where asset A, asset B, asset C, asset F, and asset I are shown in this order is 6, and thus path 41 is identified as the target path.

When in identifier 120, the total sum of the degrees of safety is greater than or equal to the first threshold value (Yes in S24), outputter 130 outputs a union of the paths in which the total sum of the degrees of safety is lower than the first threshold value, that is, the identified target paths (S30).

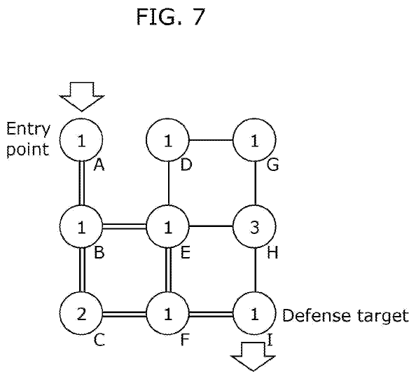

FIG. 7 is a diagram showing the union of the target paths shown in FIG. 6. In the present embodiment, outputter 130 outputs the path information indicating the union shown in FIG. 7. Since as shown in FIG. 7, the path information is indicated by the union of the target paths, even when the degree of safety of only one of asset C and asset E is increased, the other path is present, with the result that it is easily found that security measures for asset I serving as the defense target is not sufficient.

The form in which outputter 130 outputs the path information is not particularly limited. For example, outputter 130 may display a graph shown in FIG. 7 on a display. Outputter 130 may also indicate, in text, information for identifying the assets located on the union of the target paths. Examples of the information for identifying the assets include asset names, installation positions, and the like.

As described above, in risk analyzer 100 according to the present embodiment, the shortest path method is used, and thus paths in which the total sum of the degrees of safety is low can be identified as the target paths without being omitted. Since it is not necessary to identify a path in which the total sum of the degrees of safety is high, it is possible to reduce the amount of computation necessary for identifying the target paths. Since the path information on the identified target paths is output, it is found that measures for increasing the degree of safety of the assets on the target paths should be taken, with the result that it is possible to easily take security measures. As described above, in the present embodiment, it is possible to support sufficient measures for increasing the security of the defense target.

### [Variation]

A variation of Embodiment 1 will be described below. Specifically, a case where inputter 110 receives, as inputs, a plurality of entry points and a plurality of defense targets will be described.

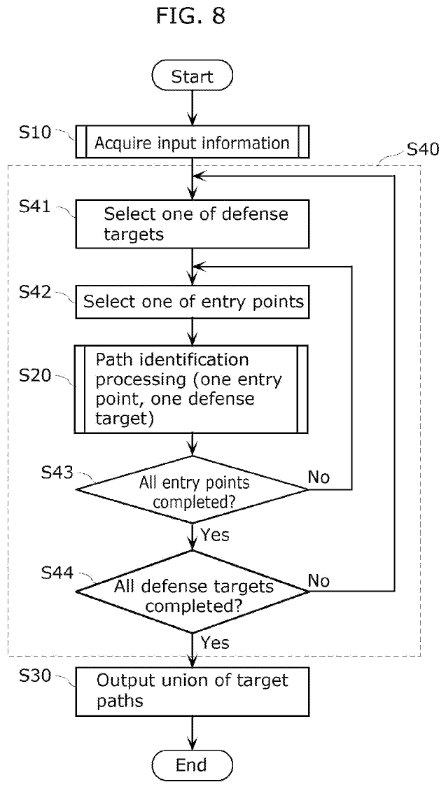

FIG. 8 is a flowchart showing the operation of risk analyzer 100 according to the present variation. As shown in FIG. 8, inputter 110 first acquires the input information (S10). Specifically, inputter 110 acquires a list of assets, the degrees of safety, the connection relationship, the entry points, the defense targets, and the first threshold value (S11 to S16 shown in FIG. 3). The present variation differs from Embodiment 1 in that, at this time, inputter 110 acquires a plurality of entry points and a plurality of defense targets in steps S14 and S15.

Then, based on the information acquired by inputter 110, identifier 120 uses the shortest path method to identify the target paths (S40). Processing indicated in step S40 is processing for identifying the target paths when a plurality of pieces are provided for at least one of the entry point and the defense target. Identifier 120 identifies the target path for each of the combinations of the entry points and the defense targets.

Specifically, identifier 120 first selects one of the defense targets (S41). Furthermore, identifier 120 selects one of the entry points (S42). Either of the selection of the defense target and the selection of the entry point may first be performed. The defense target and the entry point are selected from among the defense targets and the entry points which are not selected.

Based on the one defense target and the one entry point which are selected, identifier 120 identifies the target path as in Embodiment 1 (S20). Specifically, identifier 120 performs the processing of steps S21 to S26 shown in FIG. 3.

Then, until the processing for identifying the target paths for all the input entry points is completed (No in S43), identifier 120 repeatedly performs the selection of an unselected entry point and the identification of the target path (S42 and S20). When the processing for identifying the target paths for all the input entry points is completed (Yes in S43), until the processing for identifying the target paths for all the input defense targets is completed (No in S44), identifier 120 repeatedly performs the selection of an unselected defense target, the selection of an unselected entry point, and the identification of the target path (S41 to S43).

When the processing for identifying the target paths for all the input defense targets is completed (Yes in S44), outputter 130 outputs the path information indicting the union of the identified target paths (S30).

As described above, in the present variation, when a plurality of entry points and a plurality of defense targets are input, identifier 120 identifies the target path for each of the combinations of the entry points and the defense targets. In this way, the target paths are identified regardless of the numbers of entry points and defense targets, and thus it is possible to support sufficient measures for increasing the security of the defense target.

Although in the present variation, the example is described where both a plurality of entry points and a plurality of defense targets are acquired, a plurality of pieces may be acquired for only one of the entry point and the defense target. For example, when a plurality of entry points and only one defense target are acquired, identifier 120 does not need to perform the processing for selecting the defense target (S41) and the processing for determining the completion (S44). When only one entry point and a plurality of defense targets are acquired, identifier 120 does not need to perform the processing for selecting the entry point (S42) and the processing for determining the completion (S43).

### Embodiment 2

Embodiment 2 will then be described.

In Embodiment 1, the example is described where the shortest path is derived based on the graph in which all the input elements are assumed to be vertices. By contrast, in Embodiment 2, elements in which the degree of safety is sufficiently high are excluded from all the input elements. Differences from Embodiment 1 will be mainly described below, and the description of the same parts will be omitted or simplified.

The configuration of a risk analyzer according to the present embodiment is the same as that of risk analyzer 100 according to Embodiment 1. The following description is based on risk analyzer 100 shown in FIG. 2.

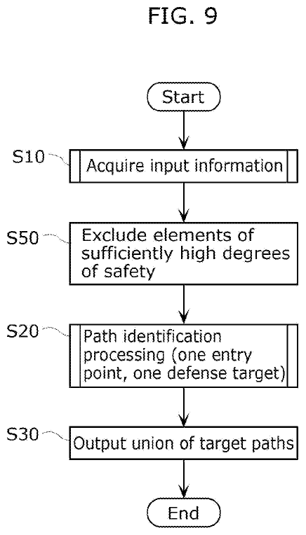

FIG. 9 is a flowchart showing the operation of risk analyzer 100 according to the present embodiment. As shown in FIG. 9, inputter 110 first acquires the input information (S10). Specifically, inputter 110 acquires a list of assets, the degrees of safety, the connection relationship, the entry point, the defense target, and the first threshold value (S11 to S16 shown in FIG. 3).

Then, identifier 120 excludes elements in which the degree of safety is sufficiently high (S50). Specifically, identifier 120 excludes, from the N elements, M elements in which the degree of safety is greater than or equal to a second threshold value. Here, M is a natural number. The second threshold value is a value used for comparison with the degree of safety of the asset, and is a safety criterion which needs to be satisfied by the asset. Although the second threshold value is previously determined value, the second threshold value may be a value acquired by inputter 110.

Then, as in Embodiment 1, based on N−M elements which are not excluded, identifier 120 uses the shortest path method to identify the target paths (S20). Specifically, identifier 120 performs the processing of steps S21 to S26 shown in FIG. 3. After the target paths are identified, outputter 130 outputs the path information indicting the union of the target paths (S30).

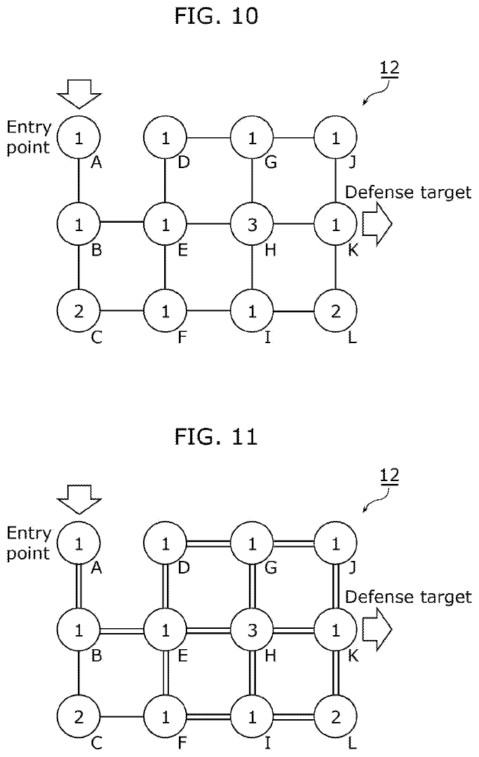

A case where control system 12 shown in FIG. 10 is input will be described below as an example.

FIG. 10 is a diagram which is produced based on the information input to the risk analyzer according to the present embodiment and which is used for illustrating an undirected graph of a system serving as the target of a risk analysis. In an example shown in FIG. 10, control system 12 is a control system formed with twelve assets A to L connected to each other. Asset A is the entry point. Asset K is the defense target.

FIG. 11 is a diagram showing a union of target paths when element exclusion processing is not performed in control system 12 shown in FIG. 10. The first threshold value used for comparison of the total sum of the degrees of safety is 9. In this case, as shown in FIG. 11, the total sum of the degrees of safety of a path which passes asset A, asset B, asset E, asset H, and asset K in this order is 7, and thus the path is identified as the target path.

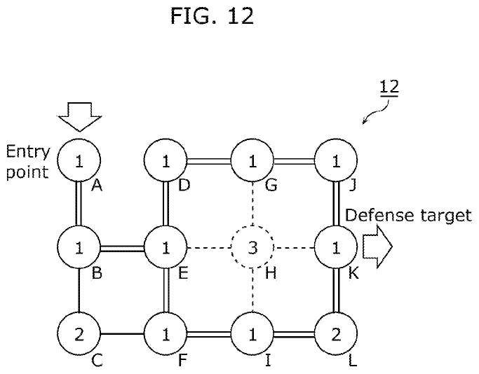

By contrast, a union of target paths when an asset is excluded is as shown in FIG. 12. FIG. 12 is a diagram showing the union of the target paths when the element exclusion processing is performed in control system 12 shown in FIG. 10. Here, as an example, the second threshold value used for comparison of the degrees of safety of assets is set to 3.

Since the second threshold value is 3, in an example shown in FIG. 12, identifier 120 excludes asset H. In other words, since the degree of safety of asset H is sufficiently high, asset H can be excluded from assets passed when asset K serving as the defense target is attacked. Identifier 120 identifies target paths based on the remaining eight assets which are not excluded and the connection relationship thereof. Hence, as shown in FIG. 12, the identified target paths are two paths which is a path passing asset 3 and a path passing asset L.

As described above, in the present embodiment, an asset is excluded, and thus it is possible to reduce the numbers of vertices and edges in a graph used for the shortest path method. Hence, it is possible to reduce the amount of computation in the shortest path method.

### [Variation]

A variation of Embodiment 2 will then be described. Specifically, a case where inputter 110 receives, as inputs, a plurality of entry points and a plurality of defense targets will be described.

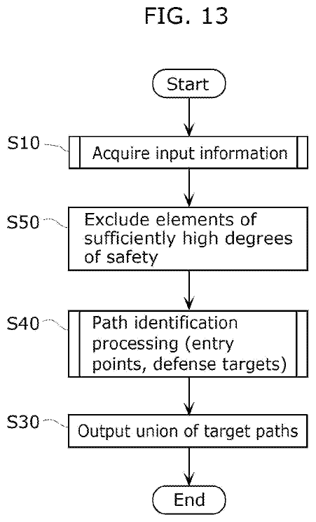

FIG. 13 is a flowchart showing the operation of risk analyzer 100 according to the present variation. As shown in FIG. 13, inputter 110 first acquires the input information (S10). Specifically, inputter 110 acquires a list of assets, the degrees of safety, the connection relationship, the entry points, the defense targets, and the first threshold value (S11 to S16 shown in FIG. 3). The present variation differs from Embodiment 2 in that, at this time, inputter 110 acquires a plurality of entry points and a plurality of defense targets in steps S14 and S15.

Then, identifier 120 excludes M elements in which the degree of safety is sufficiently high (S50). This exclusion processing is the same as that in Embodiment 2. After the exclusion of the M elements, based on N−M elements which are not excluded, identifier 120 performs processing for identifying the target paths when both a plurality of entry points and a plurality of defense targets are acquired (S40). Specifically, identifier 120 performs the processing of steps S41 to S44 shown in FIG. 8. After the target paths are identified, outputter 130 outputs the path information indicting the union of the target paths (S30).

As described above, in the present variation, when a plurality of entry points and a plurality of defense targets are input, identifier 120 identifies the target path for each of the combinations of the entry points and the defense targets. In this way, the target paths are identified regardless of the numbers of entry points and defense targets, and thus it is possible to support sufficient measures for increasing the security of the defense targets. Although the amount of computation is increased as the numbers of entry points and defense targets are increased, in the present variation, the number of elements can be reduced, and thus it is possible to support sufficient measures for increasing the security of the defense target with a small amount of computation.

Although in the present variation, the example is also described where both a plurality of entry points and a plurality of defense targets are acquired, a plurality of pieces may be acquired for only one of the entry point and the defense target.

### Embodiment 3

Embodiment 3 will then be described.

In Embodiments 1 and 2, the example is described where the system serving as the target of the risk analysis performed by risk analyzer 100 is the control system and where the assets of the control system are an example of the elements. By contrast, in Embodiment 3, an example will be described where the system serving as the target of the risk analysis is an attack procedure for assets and where N attack steps included in the attack procedure are an example of the N elements. Differences from Embodiment 1 will be mainly described below, and the description of the same parts will be omitted or simplified.

The configuration and operation of a risk analyzer according to the present embodiment are the same as those of risk analyzer 100 according to Embodiment 1. As described above, the present embodiment differs from Embodiment 1 in the system serving as the target of the risk analysis. The following description is based on risk analyzer 100 shown in FIG. 2.

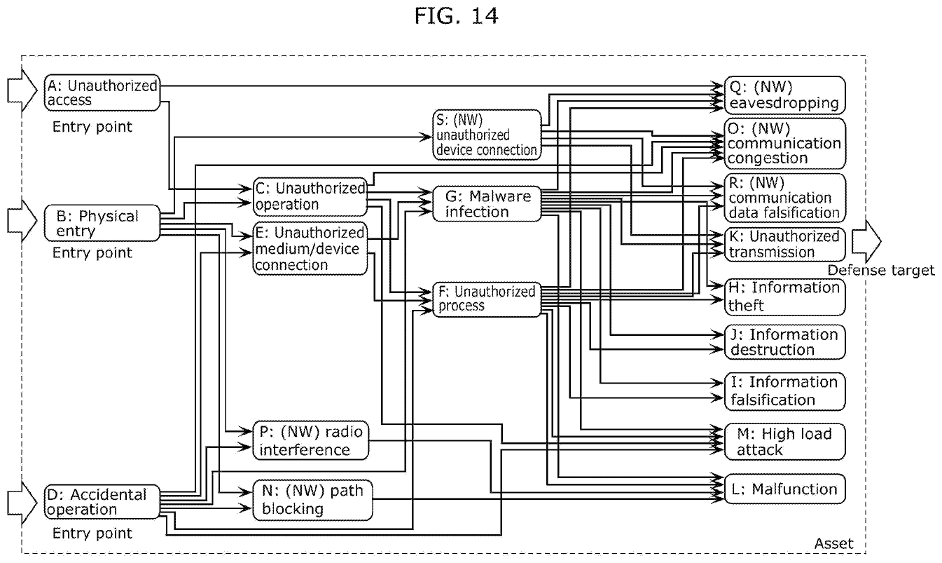

FIG. 14 is a diagram showing an example of the system serving as the target of the risk analysis performed by risk analyzer 100 according to the present embodiment. Specifically, FIG. 14 is a diagram showing an attack procedure for one of the assets of a control system.

The attack procedure for one asset includes a plurality of attack steps. The attack steps are threats used in the risk analysis. Examples of the attack steps include 19 attack steps which are A: unauthorized access, B: physical entry, C: unauthorized operation, D: accidental operation, E: unauthorized medium/device connection, F: unauthorized process performance, G: malware infection, H: information theft, I: information falsification, 3: information destruction, K: unauthorized transmission, L: malfunction, M: high load attack, N: path blocking, 0: communication congestion, P: radio interference, Q: eavesdropping, R: communication data falsification, and S: unauthorized device connection.

As shown in FIG. 14, the attack step is associated with other attack steps. For example, in order to perform the attack step of F: unauthorized process performance, it is necessary to perform such an attack step after any one of the attack steps of C: unauthorized operation, D: accidental operation, and E: unauthorized medium/device connection is performed. In other words, when F: unauthorized process performance attempts to be performed on the asset, the attack step which needs to be performed before F: unauthorized process performance is present. As described above, a plurality of attack steps have an order relationship, that is, a directed connection relationship. In FIG. 14, the order relationship is represented by arrows.

In the present embodiment, inputter 110 receives, as inputs, the degrees of safety of all the attack steps included in the attack procedure for the asset, the order relationship of the attack steps, entry points which are attack steps serving as entries to the asset, and defense targets which are attack steps to be protected in the asset. The degrees of safety, the order relationship, the entry points, and the defense targets each are objectively determined based on a predetermined method.

In risk analyzer 100 according to the present embodiment, when the risk analysis on the asset is performed, identifier 120 produces a directed graph in which all the attack steps included in the attack procedure for the asset are assumed to be vertices and in which the order relationship of the attack steps is assumed to be directed edges. The degrees of safety of the attack steps are allocated to the directed edges as weights. Specifically, the connection destination of the directed edge, that is, the degree of safety of the subsequent attack step in the order relationship is allocated. For example, the degree of safety of C: unauthorized operation is allocated as a weight to the directed edge extending from A: unauthorized access to C: unauthorized operation.

After the directed graph is produced and weights are given to the directed edges, as in Embodiment 1, identifier 120 uses the shortest path method to identify, as the target path, a path in which a total sum of the degrees of safety is lower than the first threshold value. In FIG. 14, as the entry points, three attack steps (specifically, A: unauthorized access, B: physical entry, and D: accidental operation) are input. Hence, identifier 120 performs steps S41 to S44 along the flowchart shown in FIG. 8 to identify the target paths.

As described above, in the present embodiment, it is possible to perform the risk analysis on the attack procedure for the assets of the control system, and thus it is possible to support sufficient measures for increasing the security of the defense targets.

### Embodiment 4

Embodiment 4 will then be described.

Embodiment 4 corresponds to a combination of Embodiment 1 and Embodiment 3. Specifically, a connection relationship between a plurality of assets is established based on the connection relationship of attack steps included in an attack procedure for each of the assets. More specifically, a plurality of attack steps included in an attack procedure for each of a plurality of assets of a control system are an example of the N elements. Differences from Embodiments 1 and 3 will be mainly described below, and the description of the same parts will be omitted or simplified.

The configuration and operation of a risk analyzer according to the present embodiment are the same as those of risk analyzer 100 according to Embodiment 1. As described above, the present embodiment differs from Embodiment 1 in the system serving as the target of the risk analysis. The following description is based on risk analyzer 100 shown in FIG. 2.

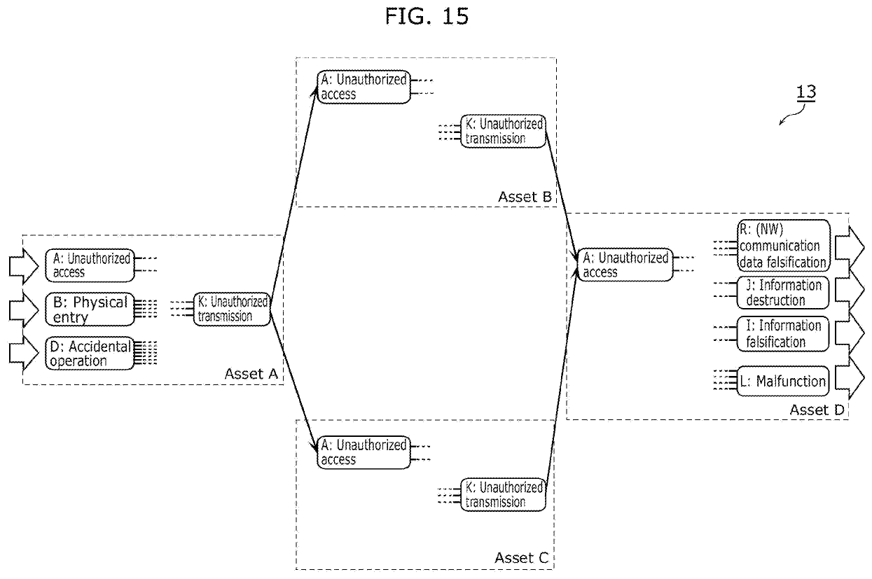

FIG. 15 is a diagram showing an example of the system serving as the target of the risk analysis performed by risk analyzer 100 according to the present embodiment. Specifically, FIG. 15 shows four assets A to D of control system 13 and an attack procedure for each of four assets A to D. Although not shown in FIG. 15 in order to prevent the figure from being complicated, the attack procedure for each of four assets A to D includes the 19 attack steps shown in FIG. 14.

As shown in FIG. 15, asset A is connected to each of asset B and asset C. Asset D is connected to each of asset B and asset C. The connection relationship of assets A to D is directed. Asset A is the entry point, and asset D is the defense target.

In this case, as shown in FIG. 15, when consideration is given to the attack procedure for asset A serving as the entry point, three attack steps of A: unauthorized access, B: physical entry, and D: accidental operation included in the attack procedure for asset A are entry points. When an attack on asset B attempts to be performed after the success of an attack on asset A, K: unauthorized transmission which is an attack step for asset A is utilized, and thus an attack is started from A: unauthorized access which is an attack step for asset B. As described above, the attack procedure from asset A to asset B is determined in a combination of the attack steps in asset A and asset B. For example, even when only 3: information destruction which is an attack step for asset A occurs, an attack on asset B is not achieved. After an attack on asset A, the attack of B: physical entry on asset B is not performed. Hence, the connection relationship of the assets of control system 13 can be indicated by the connection relationship of the attack steps included in the attack procedures for the assets.

In risk analyzer 100 according to the present embodiment, when the risk analysis on the assets is performed, identifier 120 produces a directed graph in which all the attack steps included in the attack procedures for all the assets of control system 13 are assumed to be vertices and in which the order relationship of the attack steps is assumed to be directed edges. For example, when each of assets A to D includes the 19 attack steps shown in FIG. 14, the number of vertices in the directed graph is 76 (=19×4). The degrees of safety of the attack steps are allocated to the directed edges as weights. A method for allocating the degrees of safety is the same as in Embodiment 3.

After the directed graph is produced and the weights are given to the directed edges, as in Embodiment 1, identifier 120 uses the shortest path method to identify, as the target path, a path in which a total sum of the degrees of safety is lower than the first threshold value. In FIG. 15, as the entry points, three attack steps (specifically, A: unauthorized access, B: physical entry, and D: accidental operation) in asset A are input. As the defense targets, four attack steps (specifically, I: information falsification, 3: information destruction, L: malfunction, and R: communication data falsification) in asset D are input. Hence, identifier 120 performs step S40 along the flowchart shown in FIG. 8 to identify the target paths.

As described above, in the present embodiment, it is possible to perform the risk analysis on the attack procedures for all the assets of control system 13, and thus it is possible to support sufficient measures for increasing the security of the defense targets on control system 13.

Although in the present embodiment, the example is described where all the attack steps included in the attack procedures for four assets A to D of control system 13 are elements, attack steps included in an attack procedure only for at least one of four assets A to D and one or more assets with no consideration given to the attack procedure may be elements.

### Other Embodiments

Although the risk analyzer and the risk analysis method according to one or a plurality of aspects are described above based on the embodiments, the present disclosure is not limited to these embodiments. Different types of variations conceived by those skilled in the art on the present embodiment and embodiments formed by combining constituent elements in different embodiments are also included within a range of the present disclosure without departing from the spirit of the present disclosure.

For example, although in the embodiments described above, the example is described where the degree of safety means that as its value is increased, safety against a threat to security is increased, there is no limitation on this example. The degree of safety may mean that as its value is increased, safety against a threat to security is lowered. In this case, the degree of safety can be replaced by the degree of risk indicating the level of risk. Inputter 110 may receive, as an input, the degree of risk which indirectly indicates, as the degree of safety, safety against a threat to security. The degree of risk has a negative correlation with the degree of safety described in the embodiments.

In the embodiments described above, processing performed by a specific processor may be performed by another processor. The order of a plurality of types of processing may be changed or a plurality of types of processing may be performed simultaneously. For example, at least one of inputter 110, identifier 120, and outputter 130 in risk analyzer 100 may be included in another device.

In this case, a communication method between devices is not particularly limited. When wireless communication is performed between the devices, a wireless communication system (communication standard) is, for example, near field wireless communication such as ZigBee (registered trademark), Bluetooth (registered trademark), or a wireless local area network (LAN). The wireless communication system (communication standard) may also be communication through a wide area communication network such as the Internet. Between the devices, instead of wireless communication, wired communication may be performed. Specifically, the wired communication is, for example, communication using power line communication (PLC) or a wired LAN.

For example, processing described in the above embodiments may be realized by centralized processing using a single device (system) or may be realized by distributed processing using a plurality of devices. Either a single processor or a plurality of processors may execute the programs described previously. In other words, centralized processing may be performed or distributed processing may be performed.

In the embodiments described above, all or part of the constituent elements of the device may be formed by dedicated hardware or may be realized by executing a software program suitable for each of the constituent elements. A program executor such as a central processing unit (CPU) or a processor may read and execute a software program recorded in a recording medium such as a hard disk drive (HDD) or a semiconductor memory so as to realize the constituent elements.

The constituent elements of the device may be formed with one or a plurality of electronic circuits. The one or a plurality of electronic circuits each may be a general-purpose circuit or a dedicated circuit.

In the one or a plurality of electronic circuits, for example, a semiconductor device, an integrated circuit (IC), a large scale integration (LSI) circuit, or the like may be included. The IC circuit or the LSI circuit may be integrated into one chip. Although the circuit is referred to as the IC circuit or the LSI circuit, how the circuit is referred to is changed depending on the degree of integration, and the circuit may be referred to as a system LSI circuit, a very large scale integration (VLSI) circuit, or an ultra large scale integration (ULSI) circuit. A field programable gate array (FPGA), which is programmed after the manufacturing of its LSI circuit, can be used for the same purpose.

The general or specific aspects of the present disclosure may be realized by a system, a device, a method, an integrated circuit, or a computer program. The general or specific aspects may also be realized by a non-transitory computer-readable recording medium such as an optical disc, a HDD, or a semiconductor memory in which the computer program is stored. The general or specific aspects may also be realized by any combination of a system, a device, a method, an integrated circuit, a computer program, and a recording medium.

In the embodiments described above, various types of change, replacement, addition, omission, and the like can be performed in the scope of claims or a scope equivalent thereto.

### FURTHER INFORMATION ABOUT TECHNICAL BACKGROUND TO THIS APPLICATION

The disclosures of the following patent applications including specification, drawings and claims are incorporated herein by reference in their entirety: Japanese Patent Application No. 2019-052294 filed on Mar. 20, 2019 and PCT International Application No. PCT/JP2020/011657 filed on Mar. 17, 2020.

### INDUSTRIAL APPLICABILITY

The present disclosure can be utilized as a risk analyzer and the like which can support sufficient security measures, and, for example, the present disclosure can be utilized for the support, the risk analysis, and the like of security measures on a control system in a factory or the assets of the control system.

1. A risk analyzer that analyzes a risk of a system including N elements connected to each other, N being a natural number greater than or equal to 2, the risk analyzer comprising:
an inputter that receives, as inputs, a degree of safety of each of the N elements against a threat to security, a connection relationship of the N elements, an entry point which is an element serving as an entry to the system, and a defense target which is an element to be protected in the system;
an identifier that identifies, among one or more paths from the entry point to the defense target, based on the degrees of safety and the connection relationship of the N elements, a target path in which a total sum of the degrees of safety of elements passed while the target path extends from the entry point to the defense target is lower than a first threshold value; and
an outputter that outputs path information on the target path.

2. The risk analyzer according to claim 1,
wherein the identifier uses a shortest path method to identify the target path.

3. The risk analyzer according to claim 1,
wherein the identifier further excludes, from the N elements, M elements each having a degree of safety greater than or equal to a second threshold value, and identifies the target path based on N−M elements which are not excluded, M being a natural number of 1 or more.

4. The risk analyzer according to claim 1,
wherein the system is a control system, and
the N elements are N assets of the control system.

5. The risk analyzer according to claim 1,
wherein the system is a control system, and
the N elements are a plurality of attack steps included in attack procedures for a plurality of assets of the control system.

6. The risk analyzer according to claim 1,
wherein the system is an attack procedure for an asset of a control system, and
the N elements are N attack steps included in the attack procedure.

7. The risk analyzer according to claim 1,
wherein the inputter receives, as inputs, a plurality of entry points each being the entry point and a plurality of defense targets each being the defense target, and
the identifier identifies the target path for each combination of an entry point and a defense target from among the plurality of entry points and the plurality of defense targets.

8. The risk analyzer according to claim 1,
wherein when the identifier identifies a plurality of target paths each being the target path, the outputter outputs, as the path information, information indicating a union of the plurality of target paths.

9. A risk analysis method for analyzing a risk of a system including N elements connected to each other, N being a natural number greater than or equal to 2, the risk analysis method comprising:
receiving, as inputs, a degree of safety of each of the N elements against a threat to security, a connection relationship of the N elements, an entry point which is an element serving as an entry to the system, and a defense target which is an element to be protected in the system;
identifying, among one or more paths from the entry point to the defense target, based on the degrees of safety and the connection relationship of the N elements, a target path in which a total sum of the degrees of safety of elements passed while the target path extends from the entry point to the defense target is lower than a threshold value; and
outputting path information on the target path.
